(19) United States
(12) Patent Application Publication
(10) Pub. No.: US 2026/0298646 A1
(43) Pub. Date: Oct. 1, 2026

(54) VEHICLE CONTROL DEVICE, VEHICLE CONTROL METHOD, AND PROGRAM FOR VEHICLES WITH CARGO ON UNEVEN ROADS

(71) Applicant: HONDA MOTOR CO., LTD., Tokyo (JP)

(72) Inventors: Tim Puphal, Wako-shi (JP); Vipul Ramtekkar, Wako-shi (JP); Kenji Nishimiya, Wako-shi (JP)

(21) Appl. No.: 19/422,541

(22) Filed: Dec. 17, 2025

(30) Foreign Application Priority Data
Mar. 26, 2025 (JP) 2025-051901

(51) Int. Cl. G01C 21/34; G01C 21/36

(52) U.S. Cl. CPC G01C 21/3461; G01C 21/3691

(57) ABSTRACT

A vehicle control device including a storage medium having stored thereon computer-readable instructions and a processor connected to the storage medium, the processor executing the computer-readable instructions to: acquire cargo information relating to cargo loaded on a vehicle; acquire road surface information relating to a road surface in a travel direction of the vehicle; calculate at least a degree of damage of the cargo, which is predicted to be caused by travel of the vehicle on the road surface, based on the cargo information and the road surface information; and determine a travel profile of the vehicle at least based on the degree of damage.

### CROSS-REFERENCE TO RELATED APPLICATION

This application is based upon and claims the benefit of priority from Japanese Patent Application No. 2025-051901, filed Mar. 26, 2025, the entire content of which is incorporated herein by reference.

### BACKGROUND

### Field of the Invention

The present invention relates to a vehicle control device, a vehicle control method, and a program for vehicles with cargo on uneven roads.

### Description of Related Art

Conventionally, technologies for monitoring the status of cargo loaded onto a vehicle have been known. For example, U.S. Pat. No. 9,886,799 discloses a technology that monitors the safety level of cargo loaded onto a vehicle in real time, and sends an alert to a supervisor if the acceleration and temperature data of the vehicle exceed hazardous threshold values.

However, the technology described in U.S. Pat. No. 9,886,799 does not monitor the external environment (e.g., the road surface) in the travel direction of the vehicle, and thus does not control travel of the vehicle based on the external environment. Consequently, when a vehicle carrying cargo travels on an uneven road surface, vibrations caused by the irregularities sometimes result in damage to the cargo, which is problematic.

### SUMMARY

The present invention has been made in view of the above-mentioned circumstances, and has an object to provide a vehicle control device, a vehicle control method, and a program for vehicles with cargo on uneven roads, which are capable of preventing damage to cargo due to vibrations when a vehicle carrying the cargo travels on an uneven road surface.

A vehicle control device, a vehicle control method, and a program for vehicles with cargo on uneven roads according to the present invention adopt the following configuration.

(1): A vehicle control device according to one aspect of the present invention includes a storage medium having stored thereon computer-readable instructions and a processor connected to the storage medium, the processor executing the computer-readable instructions to: acquire cargo information relating to cargo loaded on a vehicle; acquire road surface information relating to a road surface in a travel direction of the vehicle; calculate at least a degree of damage of the cargo, which is predicted to be caused by travel of the vehicle on the road surface, based on the cargo information and the road surface information; and determine a travel profile of the vehicle at least based on the degree of damage.

(2): In the aspect (1), the processor further determines whether the road surface has a single bump or surface roughness containing a plurality of bumps. The processor calculates the degree of damage by using different calculation methods according to a result of the determination.

(3): In the aspect (2), when the road surface information contains a plurality of bumps, the processor determines whether an average distance between the plurality of bumps is equal to or smaller than a threshold value. When the average distance is determined to be equal to or smaller than the threshold value, the processor determines the plurality of bumps as surface roughness, or when the average distance between the plurality of bumps is larger than the threshold value, the processor determines the plurality of bumps as single bumps.

(4): In the aspect (2), when the road surface is determined to have a single bump, the processor calculates the degree of damage based on a height and length of the single bump, or when the road surface is determined to have surface roughness, the processor calculates the degree of damage based on an average distance and height of the plurality of bumps.

(5): In the aspect (1), the processor samples a plurality of trajectory candidates consisting of a driving path and velocity profile. The processor calculates the degree of damage for each of the plurality of sampled trajectory candidates. The processor selects, as the travel profile, a target trajectory of the vehicle from among the plurality of sampled trajectory candidates at least based on the degree of damage calculated for each of the plurality of sampled trajectory candidates.

(6): In the aspect (5), the processor calculates a risk of collision with another vehicle, utility indicating a degree of adherence to an arrival target time, and comfort for an occupant of the vehicle for each of the plurality of sampled trajectory candidates. The processor selects, as the target trajectory of the vehicle, a trajectory candidate with the smallest total cost taking the degree of damage, the collision risk, the utility, and the comfort into account.

(7): In the aspect (5), the processor further determines whether a travel lane of the vehicle is a single lane or not. When the travel lane of the vehicle is determined to be a single lane, the processor samples velocity profiles along a single driving path corresponding to the single lane. The processor calculates the degree of damage for the single driving path based on each of the sampled velocity profiles. The processor selects, as the travel profile, a velocity profile of the vehicle from among the sampled velocity profiles at least based on the degree of damage calculated for each of the sampled velocity profiles.

(8): A vehicle control method to be executed by a computer according to another aspect of the present invention includes: acquiring cargo information relating to cargo loaded on a vehicle; acquiring road surface information relating to a road surface in a travel direction of the vehicle; calculating at least a degree of damage of the cargo, which is predicted to be caused by travel of the vehicle on the road surface, based on the cargo information and the road surface information; and determining a travel profile of the vehicle at least based on the degree of damage.

(9): A program according to another aspect of the present invention causes a computer to: acquire cargo information relating to cargo loaded on a vehicle; acquire road surface information relating to a road surface in a travel direction of the vehicle; calculate at least a degree of damage of the cargo, which is predicted to be caused by travel of the vehicle on the road surface, based on the cargo information and the road surface information; and determine a travel profile of the vehicle at least based on the degree of damage.

According to the aspects (1) to (9), it is possible to prevent damage to cargo due to vibrations when a vehicle carrying the cargo travels on an uneven road surface.

According to the aspects (2) to (4), it is possible to prevent damage to cargo due to vibrations more effectively by changing the calculation method for the degree of damage according to the type of irregularities of a road surface.

According to the aspect (5), it is possible to select, as the travel profile, a trajectory candidate with the minimum damage to cargo from among a plurality of trajectory candidates of a vehicle.

According to the aspect (6), it is possible to select, as the travel profile, a trajectory candidate that achieves reduction of damage to cargo and convenience for occupants of a vehicle from among a plurality of trajectory candidates of the vehicle.

According to the aspect (7), it is possible to reduce calculation costs by sampling only the velocity profiles without sampling different path candidates.

### BRIEF DESCRIPTION OF THE DRAWINGS

FIG. 1 is a diagram illustrating an example of the configuration of a system including a vehicle and a vehicle control device.

FIG. 2 is a diagram illustrating an example of road surface information related to a single bump, which is acquired by a road surface information acquisition unit.

FIG. 3 is a diagram illustrating an example of road surface information related to surface roughness, which is acquired by the road surface information acquisition unit.

FIG. 4 is a diagram explaining the process of determining whether the surface is considered as a single bump or surface roughness executed by the determination unit.

FIG. 5 is a flow chart illustrating an example of a flow for calculating a degree of damage according to whether a bump or surface roughness is detected.

FIG. 6 is a diagram illustrating an example of trajectory candidates sampled by the trajectory candidate sampling unit.

FIG. 7 is a diagram for explaining a calculation method for a collision risk calculated by a cost calculation unit.

FIG. 8 is a diagram for explaining a calculation method for utility calculated by the cost calculation unit.

FIG. 9 is a diagram for explaining a calculation method for comfort calculated by the cost calculation unit.

FIG. 10 is a diagram illustrating an example of velocity profiles sampled by the trajectory candidate sampling unit when the vehicle travels in a single lane.

FIG. 11 is a flow chart illustrating an example of a flow of processing executed by the vehicle control device.

FIG. 12 is a flow chart illustrating another example of the flow of processing executed by the vehicle control device.

### DESCRIPTION OF EMBODIMENTS

In the following, an embodiment of the vehicle control device, vehicle control method, and program of the present invention will be described with reference to the drawings. In this embodiment, a “vehicle” refers to any type of vehicle capable of traveling while carrying cargo, including passenger cars, trucks, trailers, agricultural vehicles, and work vehicles. From the perspective of the power source, the vehicle may be, for example, a gasoline-powered vehicle, a hybrid vehicle, an electric vehicle, or a fuel cell vehicle. Furthermore, in this embodiment, the vehicle is configured to be capable of autonomous travel and may therefore be unmanned; however, an operator may also be onboard. In the following description, a truck is used as an example of the vehicle.

### [Overall Configuration]

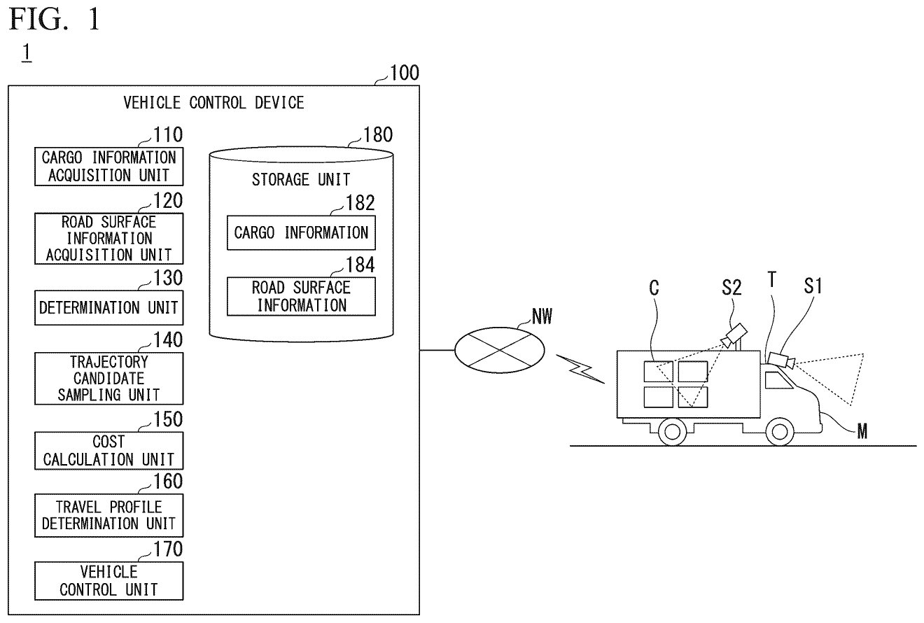

FIG. 1 is a diagram illustrating an example of the configuration of a system 1 including a vehicle T and a vehicle control device 100. The vehicle control device 100 communicates with the vehicle T via a network NW and executes travel control for the vehicle T. The network NW includes the Internet, a wide area network (WAN), a local area network (LAN), public telephone lines, provider equipment, dedicated lines, wireless base stations, and other communication infrastructures.

As another example, the vehicle control device 100 may be installed in the vehicle T, and the network NW may be omitted. In the following description, it is assumed that a camera installed in vehicle T transmits captured images to the vehicle control device 100 via the network NW. However, if the vehicle control device 100 is installed in the vehicle T, the vehicle control device 100 can directly acquire and process the captured images immediately.

The vehicle T includes a front monitoring camera S1, which is installed at a position capable of capturing images of the road surface in the travel direction of the vehicle T, and a cargo monitoring camera S2 which is installed at a position capable of capturing images of cargo C loaded on a truck bed. The front monitoring camera S1 and the cargo monitoring camera S2 may be any type of camera such as stereo cameras, monocular cameras, or RGB-D cameras (depth cameras), as long as they are capable of measuring a distance in addition to capturing two-dimensional images. In FIG. 1, as an example, a single cargo monitoring camera S2 is installed on the truck bed of the vehicle T. However, multiple cargo monitoring cameras S2 may be installed at different angles to capture images of the cargo C from various perspectives. The front monitoring camera S1 is installed at a position capable of capturing the road surface in the travel direction of the vehicle T, such as the upper part of the front windshield or the back of the rearview mirror.

The vehicle control device 100 includes, for example, a cargo information acquisition unit 110, a road surface information acquisition unit 120, a determination unit 130, a trajectory candidate sampling unit 140, a cost calculation unit 150, a travel profile determination unit 160, a vehicle control unit 170, and a storage unit 180. The cargo information acquisition unit 110, the road surface information acquisition unit 120, the determination unit 130, the trajectory candidate sampling unit 140, the cost calculation unit 150, the travel profile determination unit 160, and the vehicle control unit 170 are each implemented by a hardware processor such as a CPU (Central Processing Unit) executing a program (software). A part or all of the components may be implemented by hardware (circuit; including circuitry) such as an LSI (Large Scale Integration), an ASIC (Application Specific Integrated Circuit), an FPGA (Field-Programmable Gate Array), or a GPU (Graphics Processing Unit), or may be implemented by cooperation between software and hardware. The program may be stored in advance in a storage device (storage device including a non-transitory storage medium) of the vehicle control device 100 such as an HDD or a flash memory, or the program may be stored in a removable storage medium such as a DVD or a CD-ROM. Then, the storage medium (non-transitory storage medium) may be mounted on a drive device so that the program is installed into an HDD or a flash memory of the vehicle control device 100.

The storage unit 180 may be implemented using various storage devices mentioned above, or with EEPROM (Electrically Erasable Programmable Read-Only Memory), ROM (Read-Only Memory), RAM (Random Access Memory), or similar memory types. The storage unit 180 stores cargo information 182 acquired by the cargo information acquisition unit 110 and road surface information 184 acquired by the road surface information acquisition unit 120. Additionally, the storage unit 180 may store other necessary information for executing travel control in this embodiment, such as map information, various other types of information, and programs.

### [Acquisition of Cargo Information]

The cargo information acquisition unit 110 acquires an image of the cargo C captured by the cargo monitoring camera S2 mounted on the vehicle T, and acquires parameters for identifying the cargo C based on the acquired image. After the cargo information acquisition unit 110 acquires parameters for identifying the cargo C, the cargo information acquisition unit 110 stores these parameters in the storage unit 180 as the cargo information 182. Here, the parameters for identifying the cargo C may include, for example, the size of the cargo C (such as width, length, and height). The cargo information acquisition unit 110 can acquire these parameters by applying known computer vision processing to the acquired image of the cargo C. For instance, the cargo information acquisition unit 110 may precompute the resolution based on the field of view of the cargo monitoring camera S2, extract the pixel count of the cargo C from the image, and convert the pixel count into actual dimensions. Alternatively, the cargo information acquisition unit 110 may acquire cargo C parameters by inputting an image of the cargo C into a machine learning model trained to output the size of an object (cargo C in this case) contained in the image. In this case, the machine learning model may be implemented using, for example, a convolutional neural network (CNN) model or a transformer model.

The cargo information acquisition unit 110 further estimates the mass of the cargo C as a parameter for identifying the cargo C based on the image. For example, the cargo information acquisition unit 110 first estimates the material of the cargo C from the image, and then estimates the mass based on the size and the estimated material of the cargo C. As an example of materials, cargo C made of materials such as foam, polymer, or glass is estimated to have a lighter mass than cargo C made of materials such as iron, concrete, or steel. The cargo information acquisition unit 110 may estimate the mass based on size and material using a rule-based approach or by inputting the size and material into a pre-trained machine learning model. Alternatively, for example, the cargo information acquisition unit 110 may estimate the mass of the cargo C by acquiring images from the cargo monitoring camera S2 in a time series, and estimating the mass based on the displacement of the cargo C during acceleration or deceleration of the vehicle T.

The cargo information acquisition unit 110 further estimates the stability of the cargo C as a parameter for identifying the cargo C based on the image. Similar to mass estimation, for example, the cargo information acquisition unit 110 may acquire images from the cargo monitoring camera S2 in a time series and evaluate that the greater the displacement of the cargo C during acceleration or deceleration of the vehicle T, the lower its stability. Alternatively, for example, the cargo information acquisition unit 110 may estimate the stability of the cargo C by measuring a position relative to the floor, and a distance from other pieces of cargo C (e.g., distance from the center of gravity) based on the image of the cargo C, and may evaluate that the higher the position of the cargo C or the greater the measured distance (the farther it is from other pieces of cargo C), the lower its stability. Alternatively, for example, the cargo information acquisition unit 110 may evaluate the stability of the cargo C by inputting an image of the cargo C into a machine learning model trained on labeled training data in which pieces of cargo C with lower stability are assigned lower evaluation values in advance.

The cargo information acquisition unit 110 further estimates the durability of the cargo C as a parameter for identifying the cargo C based on the image. For example, the cargo information acquisition unit 110 may predefine durability evaluation values for the materials of pieces of cargo C and store them in the storage unit 180. By referring to the storage unit 180, the cargo information acquisition unit 110 can estimate the durability of the cargo C. Alternatively, for example, the cargo information acquisition unit 110 may estimate the durability of the cargo C by creating a 3D model of the cargo C using finite element analysis (FEM) and analyzing the forces acting on the cargo C based on its positional relationship with other pieces of cargo C.

The cargo information acquisition unit 110 further estimates the center of gravity of the cargo C as a parameter for identifying the cargo C based on the image. For example, the cargo information acquisition unit 110 may consider the center of gravity of the cargo C as the center of the cargo C itself. In this case, the cargo information acquisition unit 110 assumes that the mass of the cargo C is evenly distributed within the cargo C. Alternatively, for example, the cargo information acquisition unit 110 may perform shape analysis on the cargo C captured in the image, and estimate the center of gravity of the cargo C. Here, shape analysis means, for example, dividing the three-dimensional shape of the cargo C into multiple rectangles, calculating the center of gravity for each rectangle, and calculating the average value of the centers of gravity to estimate the center of gravity of the cargo C. Alternatively, for example, the cargo information acquisition unit 110 may acquire the center of gravity of the cargo C by inputting an image of the cargo C into a machine learning model trained to output the center of gravity of an object (cargo C in this case) contained in the image.

As a simpler method for acquiring these parameters (size, mass, stability, durability, center of gravity) for identifying cargo C, an RFID (Radio Frequency Identification) tag or image code containing the parameters of cargo C may be attached to each cargo C. When an RFID is used, a reader (or antenna) may be installed on the truck bed of the vehicle T, and the reader can read the parameter information stored in the RFID tag, and transmit it to the vehicle control device 100. When an image code is used, the parameter information can be read from the image code contained in an image captured by the cargo monitoring camera S2 and transmitted to the vehicle control device 100.

### [Acquisition of Road Surface Information]

The road surface information acquisition unit 120 acquires an image of the road surface captured by the cargo monitoring camera S2 mounted on the vehicle T, and acquires parameters for identifying a bump B present on the road surface based on the image. After the road surface information acquisition unit 120 acquires parameters for identifying the bump B, the road surface information acquisition unit 120 stores these parameters in the storage unit 180 as road surface information 184. Here, the parameters for identifying the bump B include, for example, the position, height (amplitude), and length of the bump along the direction of the vehicle T. The bump B may be detected as a bump as long as the bump B has a height above a predetermined value (e.g., several centimeters) from the road surface.

In the following description, the focus is placed on bumps B that have a height above a predetermined value from the road surface. However, the parameters to be acquired may also include depressions with a height below a predetermined value from the road surface. In such cases, the parameters of the depression can be processed in the same way as the bump B by reversing the sign of the parameters of the bump B with respect to the vertical direction.

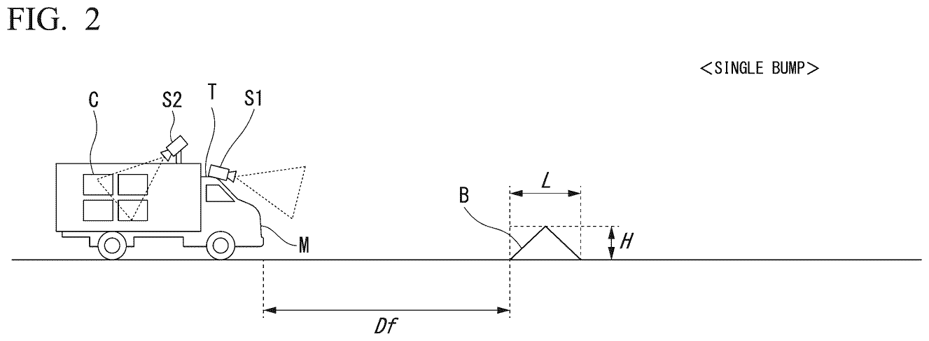

FIG. 2 is a diagram illustrating an example of the road surface information 184 related to a single bump, which is acquired by the road surface information acquisition unit 120. In FIG. 2, symbol Df represents a distance from the vehicle T to the bump B (the position of bump B), symbol H represents the height (amplitude) of the bump B, and symbol L represents the length of the bump B.

The road surface information acquisition unit 120 can detect a bump B and acquire the parameters by applying known computer vision model processing (e.g., edge detection, texture analysis, color analysis) to the acquired road surface image. Alternatively, for example, the road surface information acquisition unit 120 can acquire parameters for a single bump B by inputting the road surface image into a machine learning model trained to output a bump B and the parameters from the image. In this case, the machine learning model may be, for example, a convolutional neural network (CNN) model.

Furthermore, when there are a large number of bumps B (e.g., equal to or larger than a predetermined count) within a certain range, the road surface information acquisition unit 120 acquires the road surface information 184 by collectively identifying the bumps B as surface roughness. In this case, the parameters for identifying surface roughness include, for example, the position of the surface roughness along the travel direction of the vehicle T, the height (amplitude) of the surface roughness, and an interval (distance) between bumps. The surface roughness reflects fine and uneven vibrations experienced by the vehicle T during travel.

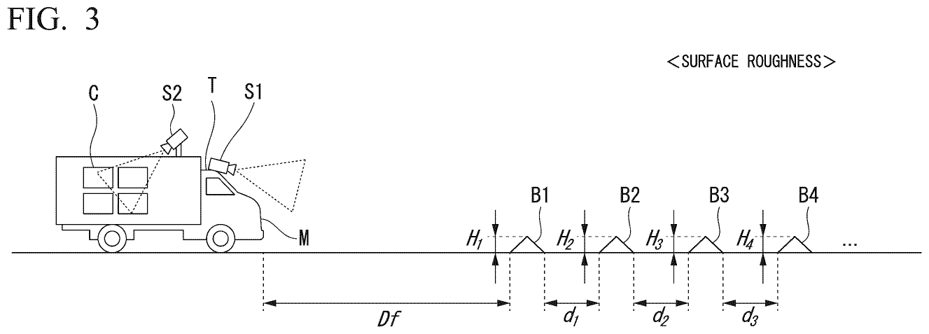

FIG. 3 is a diagram illustrating an example of the road surface information 184 related to surface roughness, which is acquired by the road surface information acquisition unit 120. FIG. 3 illustrates a case where the road surface information acquisition unit 120 acquires parameters related to surface roughness including multiple bumps B1 to B4 as an example. In FIG. 3, the symbol Df represents a distance from the vehicle T to a start point (i.e., first bump B1) of surface roughness, symbols H₁ to H₄ represent the heights (amplitudes) of the multiple bumps B1 to B4, and symbols d₁ to d₃ represent the intervals between the multiple bumps B1 to B4. The road surface information acquisition unit 120 can acquire the surface roughness height A as a statistical value (such as the mean or median) of the heights H₁ to H₄ of the multiple bumps B1 to B4, and also acquire the surface roughness interval d as a statistical value (such as the mean or median) of the intervals d₁ to d₃ of the multiple bumps B1 to B4. Alternatively, the surface roughness can be estimated based on a machine learning model that is trained to output surface roughness based on an image input.

As another embodiment, the road surface information acquisition unit 120 may detect the type of road surface (such as grass, gravel, asphalt, cobblestones, etc.) and use the detected type to acquire the parameters for surface roughness. For example, the road surface information acquisition unit 120 may use a first machine learning model trained to output road surface types in response to input of an image, and improve the acquired parameters for surface roughness by providing the detected road surface type to a second machine learning model trained to output parameters for surface roughness in response to the road surface type and an input of the image. This is because each type of road surface has its own specific roughness characteristics, and accurately identifying the surface type leads to improved estimation accuracy of roughness.

Furthermore, as another embodiment, the road surface information acquisition unit 120 can utilize transfer learning to acquire the road surface information 184. Through transfer learning, pre-trained models such as ResNet can be fine-tuned based on similar tasks and adapted to a specific road surface dataset. Additionally, for example, the road surface information acquisition unit 120 can use, in addition to images obtained by the front monitoring camera S1, depth information from other sensors, such as a LIDAR sensor, to thereby enable more robust road surface detection. Additionally, for example, the road surface information acquisition unit 120 may acquire the road surface information 184 by using an inertial measurement unit (IMU) to measure vibrations when the vehicle T travels on the road, estimate the current road surface condition on the basis of the measured vibrations, and extrapolate or predict the future road surface condition, allowing for detection of the bump B and surface roughness.

As described above, in this embodiment, the bump B and surface roughness of the road surface are primarily detected based on images acquired from the front monitoring camera S1. However, detection based on images is effective only within a certain distance from the vehicle T (e.g., within 20 meters). Therefore, the road surface information acquisition unit 120 may store past road surface information 184, which was obtained when the vehicle T previously traveled on the same road, into the storage unit 180 along with location information (e.g., GNSS coordinates) for ranges beyond a predetermined distance from the vehicle T. This allows the vehicle T, when traveling on the same road again, to reference the storage unit 180 for the road surface information 184 and acquire the road surface information for distant areas.

Furthermore, for example, the road surface information acquisition unit 120 may recognize road signs indicating a bump B or surface roughness based on images obtained by the front monitoring camera S1. The recognized road sign information can also be utilized to detect a bump B or surface roughness on the road surface. By utilizing road sign information, it is generally assumed that the bump B or surface roughness exists within a certain distance from the location of the road sign, allowing the area around that location to be scanned intensively for detection of the bump B or surface roughness.

### [Determination of Bump or Surface Roughness]

As described above, in this embodiment, the road surface information acquisition unit 120 acquires parameters related to a bump and surface roughness on the road surface in the travel direction of the vehicle T. Then, the cost calculation unit 150 calculates a degree of damage, which is predicted to be caused by the vehicle T traveling on the road surface, by using different calculation methods according to whether a bump or surface roughness is detected. However, when multiple bumps B exist on the road surface, there arises an issue of whether to treat these multiple bumps B collectively as surface roughness (and use the calculation method for surface roughness) or to treat them as individual bumps (and apply the calculation method for bumps multiple times). As described above, when there are a predetermined count or more of bumps B within a certain range, the determination unit 130 may determine the detected bumps B as surface roughness. As another example, the determination unit 130 may determine whether to treat the bumps B as surface roughness based on an average distance between the detected bumps B.

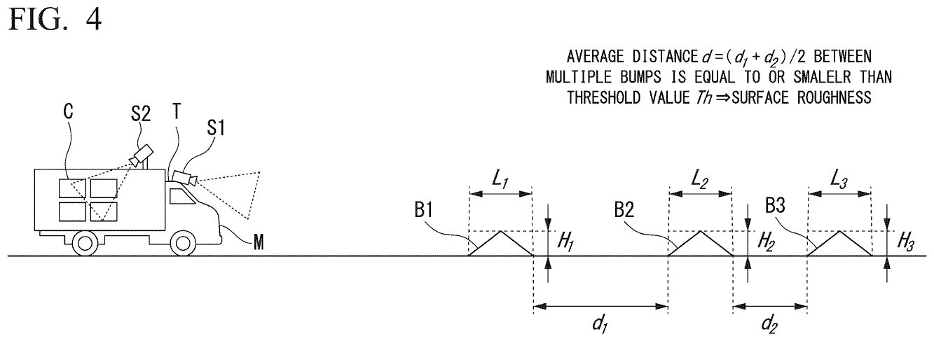

FIG. 4 is a diagram explaining the process of determining whether the surface is considered as a single bump or surface roughness executed by the determination unit 130. As shown in FIG. 4, when the determination unit 130 detects multiple bumps B, the determination unit 130 determines whether the average distance between these bumps B is equal to or less than a threshold value Th. If the average distance is determined to be equal to or less than the threshold value Th, the multiple bumps B are classified as surface roughness. For example, in the case of FIG. 4, the determination unit 130 calculates the average distance d=(d₁+d₂)/2 based on a distance d₁ between the bump B1 and the bump B2, and a distance d₂ between the bump B2 and the bump B3, to determine whether the average distance d is equal to or less than the threshold value Th.

### [Calculation of Degree of Damage]

The cost calculation unit 150 calculates the degree of damage D to the cargo C, which is predicted to be caused by the vehicle T traveling on the road surface, based on the cargo information 182 and the road surface information 184. More specifically, in this embodiment, the cost calculation unit 150 calculates the degree of damage D by using the formula D=f(Fₜₒₜₐₗ)=k(Fₜₒₜₐₗ−Fₜₕ). Here, Fₜₒₜₐₗ represents the total force acting on the cargo C, Fₜₕ represents a predefined threshold value for force, and k is a damage sensitivity coefficient that indicates the degree of damage to the cargo C due to the force acting on the cargo C. As described below, the cost calculation unit 150 calculates Fₜₒₜₐₗ by using different calculation methods according to whether a bump or surface roughness is detected by the determination unit 130.

The damage sensitivity coefficient k depends on the stability and durability parameters of the cargo C mentioned above, and is determined at the time of loading the cargo C onto the vehicle T based on these parameters. More specifically, the damage sensitivity coefficient k is set to a larger value when the stability and durability of the cargo C are lower. In another embodiment, the damage sensitivity coefficient k may be set based on other parameters. For example, the damage sensitivity coefficient k may be set to a larger value when the shift in the center of gravity of the cargo C on of the vehicle T is greater. This is because a larger shift in the center of gravity increases the risk of damage during acceleration/deceleration due to contact between the cargo C and other pieces of cargo C. Additionally, for example, the damage sensitivity coefficient k may be set to a larger value when the pitch motion (front-back oscillation) or roll motion (side-to-side oscillation) of the vehicle T body during travel is greater. This is because such oscillations can cause the cargo C to slide, increasing the risk of damage. Furthermore, for example, the damage sensitivity coefficient k may be set to a larger value when the slippiness of the truck bed surface of the vehicle T is high. This is because a more slippery truck bed surface makes the cargo C more prone to movement, thereby increasing the risk of damage.

### [Calculation of Degree of Damage Related to Bump]

The cost calculation unit 150 calculates Fₜₒₜₐₗ related to a bump according to the following equation (1).

$${F}_{t o t a l} = {F}_{bump} - {F}_{g} - {F}_{s e c u r e} - {F}_{s u spension} \qquad ( 1 )$$

In equation (1), F_{bump} represents the vertical force (upward) exerted on the cargo C due to the bump, F_{g} represents the weight of the cargo C (downward), F_{secure} represents the securing force exerted on the cargo C by a cargo securing system (opposite to F_{bump}), and Fₛᵤₛₚₑₙₛᵢₒₙ represents the suspension force of the vehicle T. F_{bump} is approximately calculated as F_{bump}~m_{c}×a_{z} (predetermined constant may be multiplied). Here, m_{c} represents the mass of the cargo C, and a_{z} represents the vertical acceleration exerted on the cargo C due to the bump. The acceleration a_{z} can be calculated using the equation a_{z}=(2H×v²)/L. Here, H and L represent the height and length of the bump B, respectively, and ν represents the velocity of the vehicle T.

The gravitational force F_{g} is calculated using F_{g}=m_{c}×g, where g represents the gravitational acceleration. The suspension force Fₛᵤₛₚₑₙₛᵢₒₙ is calculated using Fₛᵤₛₚₑₙₛᵢₒₙ=k_{s,l}×Δd1, where k_{s,l} represents the suspension stiffness, and Δd1 represents the suspension displacement from the static position. The suspension displacement Δd1 can be approximately calculated as Δd1~a_{z} (predetermined constant may be multiplied). The securing force F_{secure} is calculated using F_{secure}=k_{s,2}×Δd2, where k_{s,2} represents the stiffness constant of the cargo securing system, and Δd2 represents the relative displacement of the cargo C from its static position. The relative displacement Δd2 can be approximately calculated as Δd2~a_{z} (predetermined constant may be multiplied).

### [Calculation of Degree of Damage Related to Surface Roughness]

The cost calculation unit 150 calculates Fₜₒₜₐₗ related to surface roughness according to the following equation (2). The equation (2) is obtained by replacing F_{bump} with Fᵤₙₑᵥₑₙ in expression (1)

$${F}_{t o t a l} = {F}_{u n e v e n} - {F}_{g} - {F}_{s e c u r e} - {F}_{s u spension} \qquad ( 2 )$$

In equation (2), Fᵤₙₑᵥₑₙ represents the vertical force (upward) exerted on the cargo C by surface roughness, and is approximately calculated as Fᵤₙₑᵥₑₙ~m×(2πf_{vibration})²×A (predetermined constant may be multiplied). Here, f_{vibration} represents the number of times per unit time that force is received from surface roughness, and is calculated as f_{vibration}=v/d. The variables d and A represent the aforementioned average distance and height included in the road surface information 184.

### [Flow for Calculating Degree of Damage According to Bump or Surface Roughness]

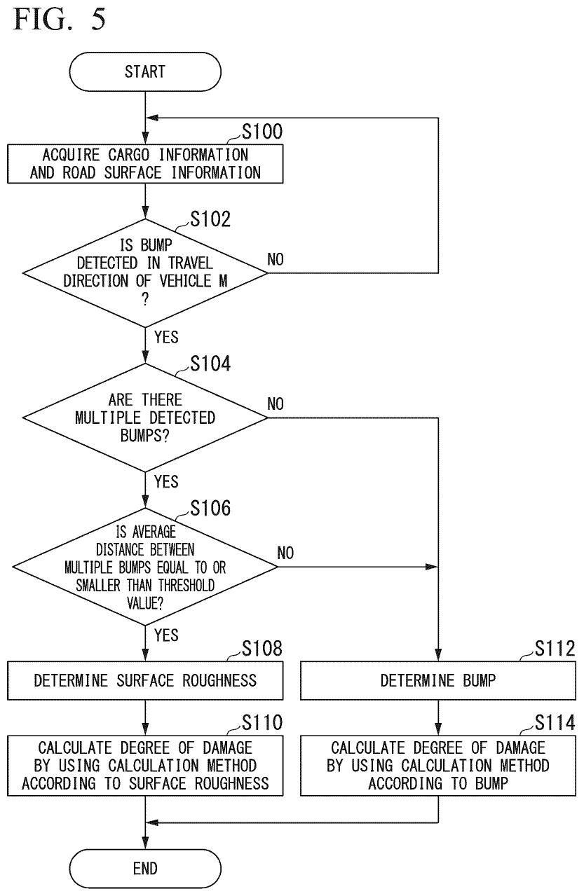

FIG. 5 is a flow chart illustrating an example of a flow for calculating a degree of damage according to whether a bump or surface roughness is detected. The processing illustrated in FIG. 5 is repeatedly executed during travel of the vehicle T after the cargo C is loaded onto the vehicle T, for example.

First, the cargo information acquisition unit 110 and the road surface information acquisition unit 120 acquire the cargo information 182 and the road surface information 184, respectively (Step S100). Next, the determination unit 130 determines whether there is a bump in the travel direction of the vehicle T based on the road surface information 184 (Step S102). When it is determined that there is no bump in the travel direction of the vehicle T, the determination unit 130 returns the processing to Step S100. On the other hand, when it is determined that there is a bump in the travel direction of the vehicle T, the determination unit 130 next determines whether there are a plurality of bumps (Step S104).

When it is determined that there are a plurality of bumps, the determination unit 130 next determines whether an average distance between the plurality of detected bumps is equal to or smaller than a threshold value (Step S106). When it is determined that an average distance between the plurality of detected bumps is equal to or smaller than the threshold value, the determination unit 130 determines the plurality of bumps as surface roughness (Step S108). Next, the cost calculation unit 150 calculates the degree of damage D by using a calculation method according to surface roughness (Step S110).

On the other hand, when it is determined in Step S104 that there are not a plurality of detected bumps, that is, a single bump is detected, or it is determined in Step S106 that an average distance between the average distance between the plurality of detected bumps is not equal to or larger than the threshold value, the determination unit 130 determines the single bump or the plurality of detected bumps as individual bumps (Step S112). Next, the cost calculation unit 150 calculates the degree of damage D by using a calculation method according to a bump (Step S114). This concludes the processing of this flow chart.

According to the processing of this flow chart described above, when bumps are detected in the travel direction of the vehicle T, it is determined whether the bumps are treated as surface roughness or individual bumps, and the degree of damage D to the cargo C due to travel of the vehicle T is calculated by using the damage calculation method according to the result of the determination. In this manner, it is possible to calculate the degree of damage D to the cargo C more accurately.

### [Sampling of Trajectory Candidate]

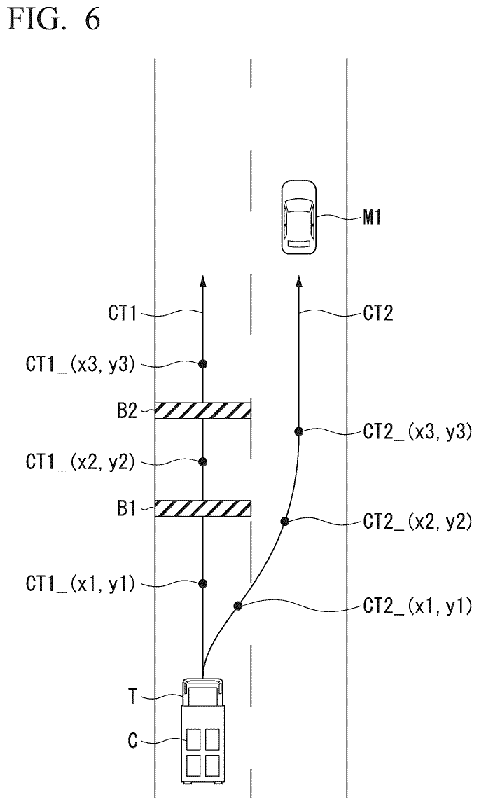

The trajectory candidate sampling unit 140 samples a plurality of trajectory candidates toward the destination of the vehicle T. FIG. 6 is a diagram illustrating an example of trajectory candidates sampled by the trajectory candidate sampling unit 140. In FIG. 6, the symbol M1 represents another vehicle. In this embodiment, “trajectory candidate” consists of a driving path and velocity profile of the vehicle T. The driving path means a combination of trajectory points that the vehicle T is to pass through in the future (without velocity information), and the velocity profile means information specifying the velocity when the vehicle T passes through the driving path. FIG. 6 illustrates an example in which the trajectory candidate sampling unit 140 samples a straight-driving trajectory candidate CT1 and a lane-changing trajectory candidate CT2 (hereinafter, multiple trajectory candidates may be collectively referred to as CT). Each trajectory candidate CT further includes trajectory points CT_(xt, yt), which are target points at an elapsed time t (seconds) from the current time point. Since the trajectory points CT_(xt, yt) represent target locations at each elapsed time t from the current time point, specifying the trajectory points CT_(xt, yt) on the trajectory candidate CT corresponds to specifying the velocity profile of the vehicle T.

The trajectory candidate sampling unit 140 can sample each trajectory candidate CT by modifying the trajectory candidate CT, and also sample the velocity profile of the vehicle T by changing the positions of the trajectory points CT_(xt, yt) at each time t on the trajectory candidate CT. The cost calculation unit 150 calculates, for each trajectory candidate CT, the degree of damage D based on the velocity v specified by the velocity profile. For example, in the case of FIG. 6, since the trajectory candidate CT1 includes bumps B1 and B2, the cost calculation unit 150 calculates the degree of damage D due to the bumps B1 and B2 by using the velocity v determined by the velocity profile of the trajectory candidate CT1. That is, in the case of FIG. 6, the cost calculation unit 150 calculates a positive degree of damage D for the trajectory candidate CT1 (sum of degree of damage D for bump B1 and degree of damage D for bump B2), while the degree of damage D for the trajectory candidate CT2 is zero.

When the trajectory candidate CT1 and the trajectory candidate CT2 are compared, the degree of damage D for the trajectory candidate CT1 exceeds that of the trajectory candidate CT2. Therefore, from the perspective of minimizing damage to the cargo C, adopting the trajectory candidate CT2 is preferable. However, in the situation shown in FIG. 6, since another vehicle M1 is present along the trajectory candidate CT2, considering a collision risk with the vehicle M1, adopting the trajectory candidate CT2 as the target trajectory is not necessarily the safest option. Furthermore, since the trajectory candidate CT2 involves a lane change, adopting the trajectory candidate CT2 may result in a longer travel time to the destination or cause sudden fluctuations in speed. In other words, the trajectory candidate CT2 may lead to reduced safety for passengers, decreased utility, or lower comfort.

Given the above circumstances, in this embodiment, the cost calculation unit 150 calculates, for each trajectory candidate, not only the degree of damage D but also the collision risk with other vehicles, utility U indicating a degree of adherence to an arrival target time, and comfort CM for the occupants of the vehicle T. The travel profile determination unit 160 then selects, as the target trajectory of the vehicle T, a trajectory candidate and corresponding velocity profile minimizing a total cost, which takes into account the calculated degree of damage D, the collision risk CR, the utility U, and the comfort CM. Hereinafter, the finally selected target trajectory of the vehicle T may be referred to as “travel profile.”

More specifically, the travel profile determination unit 160 selects, as the target trajectory, a trajectory candidate of the vehicle T for which the total cost=degree of damage D+collision risk CR−utility U−comfort CM is minimized. Here, since the utility U and the comfort CM are defined such that larger values indicate better conditions, they are subtracted when calculating the total cost. The total cost calculation does not necessarily need to consider all four of these values, and it is sufficient for at least the degree of damage D to be considered. For example, the travel profile determination unit 160 may select, as the target trajectory, a trajectory candidate of the vehicle T for which the total cost=degree of damage D+collision risk CR−utility U is minimized. An overview of the calculation methods for the collision risk R, the utility U, and the comfort CM is provided below, but for details, see T. Puphal et al., “Online and predictive warning system for forced lane changes using risk maps” for reference.

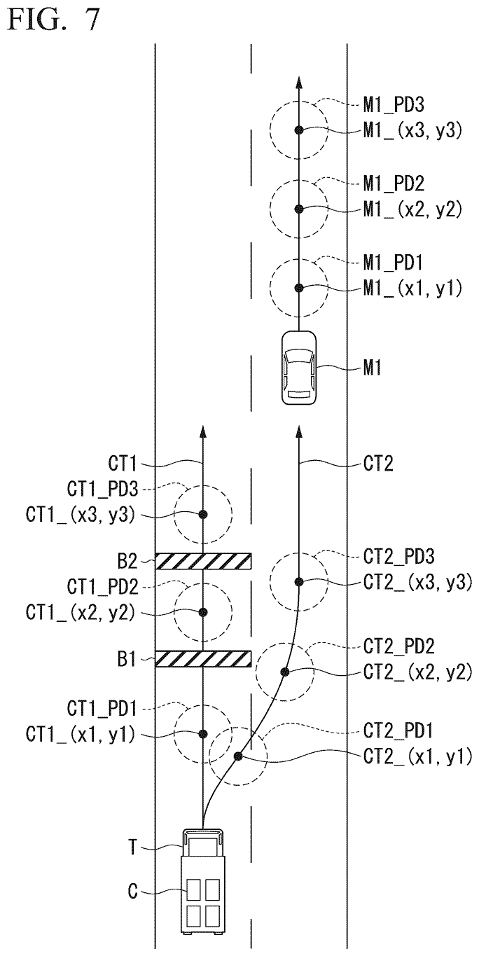

FIG. 7 is a diagram for explaining the calculation method for a collision risk calculated by the cost calculation unit 150. The specific calculation method for the collision risk R is as follows. First, the cost calculation unit 150 models the trajectory of the vehicle T as a probability distribution, such as a two-dimensional Gaussian distribution or a Poisson distribution, based on the trajectory candidate of the vehicle T. More specifically, the cost calculation unit 150 can model the trajectory of the vehicle T as a probability distribution centered on each trajectory point forming the trajectory candidate of the vehicle T. In this case, the variance may be a fixed value, or may be a value defined according to the velocity at each trajectory point. In FIG. 7, the symbol CT(K)_PD(T) represents a probability distribution centered on each trajectory point at each time T.

Simultaneously, for example, the cost calculation unit 150 acquires the images of the vehicle M1 in a time series, and predicts the position and velocity of the other vehicle M1 based on these time-series images. Next, the cost calculation unit 150 models the trajectory of the other vehicle M1 as a probability distribution, such as a two-dimensional Gaussian distribution or a Poisson distribution, based on the predicted position and velocity. More specifically, the cost calculation unit 150 can model the trajectory of the other vehicle M1 as a probability distribution centered on the location reached from the current position, assuming that the predicted velocity remains constant. Then, the cost calculation unit 150 can calculate the collision risk R as a value proportional to the product of the probability distribution of the other vehicle M1 and the probability distribution of the vehicle T (survival analysis). For example, the cost calculation unit 150 may take the sum of the values in the time series to obtain the collision risk R, or adopt the largest value in the time series as the collision risk R.

In this embodiment, for the sake of explanation, the risk value is calculated only for the collision risk R with other vehicles. However, the present invention is not limited to such a configuration, and more generally, various risk values related to safety for travel of the vehicle T can be calculated and considered. For example, in addition to the collision risk R, the risk value can be calculated by considering curvature risk (risk of deviating from curve) when the vehicle T travels on a curved path, or regulatory risk (risk of violating regulations) when entering a region where entry is restricted by law. When considering risks other than the collision risk, the total risk can be calculated by multiplying each risk by its severity, according to its type, and taking a sum of the results.

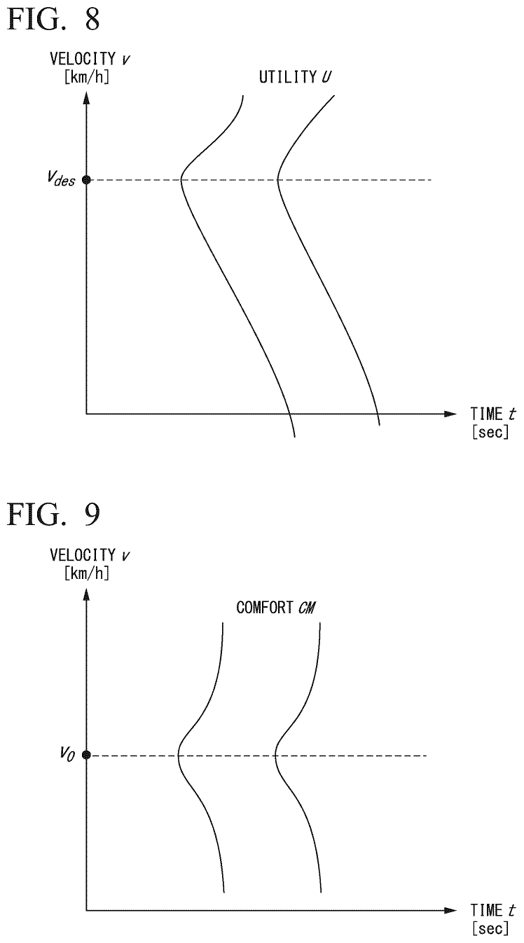

FIG. 8 is a diagram for explaining a calculation method for utility calculated by the cost calculation unit 150. FIG. 8 is a graph with the predicted time t from the current time point on the horizontal axis and the velocity v on the vertical axis. In FIG. 8, the symbol v_{des} represents the target speed for the vehicle T to arrive at the destination on time. Since this embodiment assumes that the vehicle T is traveling autonomously, the destination and arrival time are set in advance. As shown in the graph in FIG. 8, the utility U is calculated such that the closer the speed is to v_{des}, the larger the value becomes. The target speed v_{des} may be appropriately updated based on the current position of the vehicle T and the distance to the destination at a timing when the cost calculation unit 150 calculates the utility. Furthermore, the calculation method in FIG. 8 is just an example, and as an alternative embodiment, the utility U may be calculated in such a way that the earlier the arrival time at the destination (within the speed limit), the larger the value becomes.

FIG. 9 is a diagram for explaining a calculation method for comfort calculated by the cost calculation unit 150. FIG. 9 is a graph with the predicted time t from the current time point on the horizontal axis and the velocity v on the vertical axis. As shown in the graph of FIG. 9, the comfort CM is calculated such that the smaller the variation from the current speed (v₀), meaning the smaller the acceleration and/or jerk, the larger the value becomes. The calculation method shown in FIG. 9 is merely an example, and in other embodiments, the comfort CM may be calculated by considering, for instance, the number of lane changes (discrete value), with more lane changes resulting in a smaller value.

In this manner, the travel profile determination unit 160 selects, from among a plurality of trajectory candidates of the vehicle T, a trajectory candidate with the minimum total cost, which takes into account the degree of damage D, the collision risk CR, the utility U, and the comfort CM calculated by the cost calculation unit 150. As a result, it is possible to select, as the travel profile, a combination of a trajectory candidate that balances reduction of damage to the cargo and convenience for the occupants of a vehicle.

The vehicle control unit 170 controls a driving force output device, a brake system, and a steering system of the vehicle T so that the vehicle T travels according to the travel profile determined by the travel profile determination unit 160. The driving force output device outputs a driving force (torque) to the drive wheels of the vehicle for travel. The driving force output device includes, for example, a combination of an internal combustion engine, an electric motor, and a transmission, along with an ECU (Electronic Control Unit) for controlling these components. The brake system includes, for example, a brake caliper, a cylinder that transmits hydraulic pressure to the brake caliper, an electric motor that generates hydraulic pressure in the cylinder, and a brake ECU that controls the electric motor. The steering system includes, for example, a steering ECU and an electric motor. The electric motor applies force to a rack-and-pinion mechanism to change the direction of the drive wheel.

In the above embodiment, an example was explained where the trajectory candidate sampling unit 140 samples multiple trajectory candidates consisting of a driving path and velocity profile. However, for instance, when the vehicle T is traveling in a single lane or when it is impossible to avoid a bump, the trajectory candidate sampling unit 140 may generate a single driving path along the single lane and sample only multiple velocity profiles. The determination unit 130 may, for example, recognize the road lane markings of a lane, in which the vehicle T is traveling, by applying image recognition processing to images acquired by the front monitoring camera S1, and based on the recognized lane markings, determine whether the vehicle T is traveling in a single lane. Alternatively, as another example, the determination unit 130 may refer to map information based on position information (e.g., GNSS coordinates) of the vehicle T and determine whether the current position of the vehicle T is on a single lane.

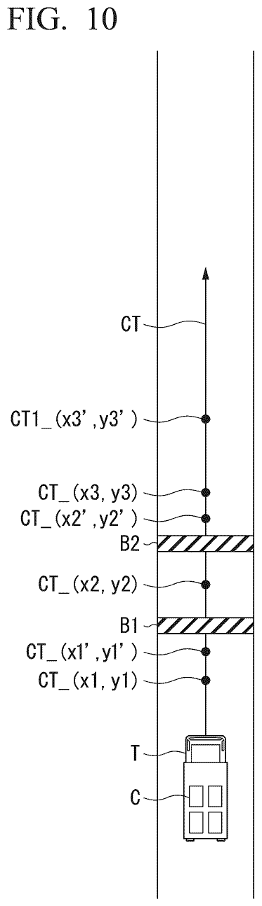

FIG. 10 is a diagram illustrating an example of velocity profiles sampled by the trajectory candidate sampling unit 140 when the vehicle T travels in a single lane. FIG. 10 illustrates a case where the determination unit 130 determines that the vehicle T is traveling in a single lane. In this case, the trajectory candidate sampling unit 140, without sampling multiple driving path candidates, samples multiple velocity profiles along a single driving path CT on the single lane. In the case of FIG. 10, the trajectory candidate sampling unit 140 generates two velocity profiles: the first velocity profile for CT_(x1, y1), CT_(x2, y2), CT_(x3, y3), and the second velocity profile for CT_(x1′, y1′), CT_(x2′, y2′), CT_(x3′, y3′). The second velocity profile has a higher speed compared to the first velocity profile.

The cost calculation unit 150 calculates the total cost for each of the first velocity profile and the second velocity profile, and the travel profile determination unit 160 selects a velocity profile with the lower total cost among these velocity profiles. The vehicle control unit 170 controls travel of the vehicle T based on the selected velocity profile. That is, according to this control, when the vehicle is traveling in a single lane, the sampling of driving path candidates is not performed, and only the sampling of velocity profiles is carried out, thereby reducing the computational cost.

In the above embodiment, an example was described in which the vehicle control unit 170 controls travel of the vehicle T according to the target trajectory determined by the travel profile determination unit 160. However, the present invention is not limited to such a configuration, and may also be applied to driver assistance. For example, a navigation system or HMI (Human-Machine Interface) installed in the vehicle T may display the target trajectory with the lowest total cost determined by the travel profile determination unit 160. This allows the driver to recognize a trajectory that minimizes the degree of damage to cargo C while ensuring convenience, even when the vehicle T is manually driven by the driver.

### [Flow of Processing]

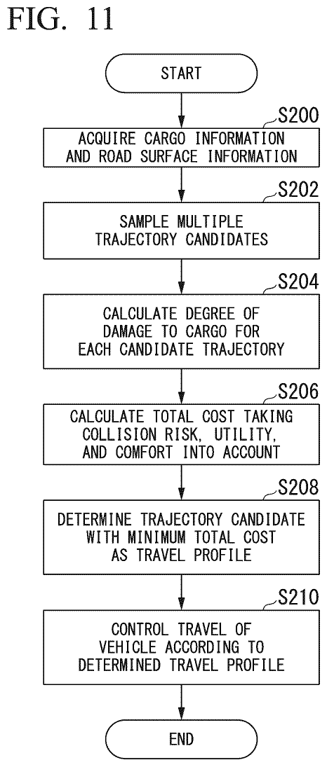

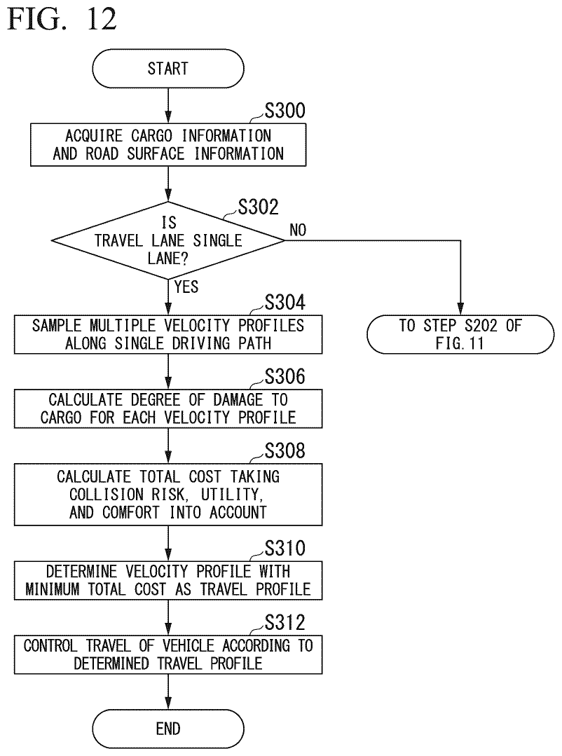

Now, a flow of processing to be executed by the vehicle control device 100 is described with reference to FIG. 11 and FIG. 12. The processing of the flow charts illustrated in FIG. 11 and FIG. 12 are repeatedly executed during travel of the vehicle T.

FIG. 11 is a flow chart illustrating an example of a flow of processing executed by the vehicle control device 100. First, the cargo information acquisition unit 110 and the road surface information acquisition unit 120 acquire the cargo information 182 and the road surface information 184, respectively (Step S200). Next, the trajectory candidate sampling unit 140 samples a plurality of trajectory candidates (Step S202). Next, the cost calculation unit 150 calculates the degree of damage to cargo for each of the sampled trajectory candidates (Step S204). In this step, the cost calculation unit 150 calculates the degree of damage by using different calculation methods according to the flow of the flow chart illustrated in FIG. 5.

Next, the cost calculation unit 150 calculates the total cost including taking the collision risk, the utility, and the comfort into account (Step S206). Next, the travel profile determination unit 160 determines a trajectory candidate with the minimum total cost as the travel profile (Step S208). Next, the vehicle control unit 170 controls travel of the vehicle T according to the determined travel profile (Step S210). This concludes the processing of this flow chart.

FIG. 12 is a flow chart illustrating another example of the flow of processing executed by the vehicle control device 100. First, the cargo information acquisition unit 110 and the road surface information acquisition unit 120 acquire the cargo information 182 and the road surface information 184, respectively (Step S300). Next, the determination unit 130 determines whether the travel lane of the vehicle T is a single lane or not (Step S302). When it is determined that the travel lane of the vehicle T is not a single lane, the vehicle control device 100 proceeds the processing to Step S202 of the flow chart of FIG. 11. On the other hand, when it is determined that the travel lane of the vehicle T is a single lane, the trajectory candidate sampling unit 140 samples a plurality of velocity profiles along the single driving path (Step S304).

Next, the cost calculation unit 150 calculates the degree of damage to the cargo for each of the sampled velocity profiles (Step S306). Next, the cost calculation unit 150 calculates the total cost taking the collision risk, the utility, and the comfort into account (Step S308). Next, the travel profile determination unit 160 determines a velocity profile with the minimum total cost as the travel profile (Step S310). Next, the vehicle control unit 170 controls travel of the vehicle T according to the determined travel profile (Step S312). This concludes the processing of this flow chart.

According to the embodiment described above, cargo information and road surface information are used for calculating at least the degree of damage to cargo, which is predicted to be caused by travel of the vehicle on the road surface. Then, the travel profile of the vehicle is determined at least based on the degree of damage, to thereby control travel of the vehicle. With this feature, it is possible to prevent damage to cargo due to vibrations when a vehicle carrying the cargo travels on an uneven road surface.

The embodiment described above can be represented in the following manner.

A vehicle control device comprising a storage medium having stored thereon computer-readable instructions and a processor connected to the storage medium, the processor executing the computer-readable instructions to:
acquire cargo information relating to cargo loaded on a vehicle;
acquire road surface information relating to a road surface in a travel direction of the vehicle;
calculate at least a degree of damage of the cargo, which is predicted to be caused by travel of the vehicle on the road surface, based on the cargo information and the road surface information; and
determine a travel profile of the vehicle at least based on the degree of damage.

Although the embodiments for implementing the present invention have been described using specific examples, the present invention is not limited to these embodiments. Various modifications and substitutions can be made without departing from the spirit and scope of the invention.

What is claimed is:

1. A vehicle control device comprising a storage medium having stored thereon computer-readable instructions and a processor connected to the storage medium, the processor executing the computer-readable instructions to:
acquire cargo information relating to cargo loaded on a vehicle;
acquire road surface information relating to a road surface in a travel direction of the vehicle;
calculate at least a degree of damage of the cargo, which is predicted to be caused by travel of the vehicle on the road surface, based on the cargo information and the road surface information; and
determine a travel profile of the vehicle at least based on the degree of damage.

2. The vehicle control device according to claim 1,
wherein the processor further determines whether the road surface has a single bump or surface roughness containing a plurality of bumps, and
wherein the processor calculates the degree of damage by using different calculation methods according to a result of the determination.

3. The vehicle control device according to claim 2,
wherein when the road surface information contains a plurality of bumps, the processor determines whether an average distance between the plurality of bumps is equal to or smaller than a threshold value, and
wherein when the average distance is determined to be equal to or smaller than the threshold value, the processor determines the plurality of bumps as surface roughness, or when the average distance between the plurality of bumps is larger than the threshold value, the processor determines the plurality of bumps as single bumps.

4. The vehicle control device according to claim 2, wherein when the road surface is determined to have a single bump, the processor calculates the degree of damage based on a height and length of the single bump, or when the road surface is determined to have surface roughness, the processor calculates the degree of damage based on an average distance and height of the plurality of bumps.

5. The vehicle control device according to claim 1,
wherein the processor further samples a plurality of trajectory candidates consisting of a driving path and velocity profile,
wherein the processor calculates the degree of damage for each of the plurality of sampled trajectory candidates, and
wherein the processor selects, as the travel profile, a target trajectory of the vehicle from among the plurality of sampled trajectory candidates at least based on the degree of damage calculated for each of the plurality of sampled trajectory candidates.

6. The vehicle control device according to claim 5,
wherein the processor calculates a risk of collision with another vehicle, utility indicating a degree of adherence to an arrival target time, and comfort for an occupant of the vehicle for each of the plurality of sampled trajectory candidates, and
wherein the processor selects, as the target trajectory of the vehicle, a trajectory candidate with the smallest total cost taking the degree of damage, the collision risk, the utility, and the comfort into account.

7. The vehicle control device according to claim 5,
wherein the processor further determines whether a travel lane of the vehicle is a single lane or not,
wherein when the travel lane of the vehicle is determined to be a single lane, the processor samples velocity profiles along a single driving path corresponding to the single lane,
wherein the processor calculates the degree of damage for the single driving path based on each of the sampled velocity profiles, and
wherein the processor selects, as the travel profile, a velocity profile of the vehicle from among the sampled velocity profiles at least based on the degree of damage calculated for each of the sampled velocity profiles.

8. A vehicle control method to be executed by a computer, the vehicle control method comprising:
acquiring cargo information relating to cargo loaded on a vehicle;
acquiring road surface information relating to a road surface in a travel direction of the vehicle;
calculating at least a degree of damage of the cargo, which is predicted to be caused by travel of the vehicle on the road surface, based on the cargo information and the road surface information; and
determining a travel profile of the vehicle at least based on the degree of damage.

9. A non-transitory computer-readable storage medium having stored thereon a program for causing a computer to:
acquire cargo information relating to cargo loaded on a vehicle;
acquire road surface information relating to a road surface in a travel direction of the vehicle;
calculate at least a degree of damage of the cargo, which is predicted to be caused by travel of the vehicle on the road surface, based on the cargo information and the road surface information; and
determine a travel profile of the vehicle at least based on the degree of damage.
